(19) United States
(12) Patent Application Publication
(10) Pub. No.: US 2010/0070638 A1
(43) Pub. Date: Mar. 18, 2010

(54) SYSTEM AND A METHOD FOR SECURED DATA COMMUNICATION IN COMPUTER NETWORKS BY PHANTOM CONNECTIVITY

(75) Inventors: Haresh Suryakant Bhatt, Karnataka State (IN); Nilesh Labhshanker Dharaiya, Karnataka State (IN); Praful Rambhai Patel, Karnataka State (IN); Vasaram Haribhai Patel, Karnataka State (IN); Arup Ranjan Dasgupta, Karnataka State (JP)

Correspondence Address: ALFRED A. STADNICKI, 1300 NORTH SEVENTEENTH STREET, SUITE 1800, ARLINGTON, VA, 22209, US

(73) Assignee: DEPARTMENT OF SPACE, ISRO, New Bel Road (IN)

(21) Appl. No.: 11/915,264

(22) PCT Filed: Apr. 12, 2007
(86) PCT No.: PCT/IN2007/000140

§ 371 Date: Dec. 4, 2009

(30) Foreign Application Priority Data
Jul. 7, 2006 (IN) 1190/CHE/2006

(51) Int. Cl. G06F 15/16

(52) U.S. Cl. 709/229

(57) ABSTRACT

The present invention provides a system for providing a higher level security to data communication in computer networks, said system comprising; an organizational network, at least a third party network, at least a phantom server with an intermediate data storage, a toggling means disposed to isolate the organizational network from the third party network and said toggling means further disposed to permit secured data communication between the organizational network and the third party network through the phantom server. A method for providing a higher level security to data communication in computer networks by effecting the transmission of data between organizational network and the third party network by toggling means through phantom server.

### TECHNICAL FIELD

The present invention is in the field of providing higher-level security to an organizational computer network. The present invention relates to a system and method to provide a higher level of security to data communication among computer networks by phantom connectivity.

### BACKGROUND OF THE PRESENT INVENTION

Data communication across the networks as well as Internet has become mandatory for all organizations to keep in touch with the rest of the world. As a result there is a large scope of security breaches in organizational network by connecting them to the Internet or other networks. There are several tools and techniques invented for the purpose of security but none is fool proof. Hence, several organizations are not connecting their network to the Internet and prefer to remain isolated. At the same time isolation does not help in satisfying communication requirements. There are many different technologies invented for organizational network security. Firewall, proxy, filters, intrusion detection system (IDS) and intrusion detection and prevention system (IDP) are prime technologies in the area. Firewall permits only authorized data communication to and from organizational network. Proxy hides the identity of the network. Filtering technology filters out the unauthorized data communications. IDS checks for unauthorized intrusion in organizational network. IDP is an extension of IDS providing a level of prevention. All of the above-mentioned technologies and other network security mechanisms need organizational network, to be connected to any external network.

U.S. Pat. No. 5,263,147 describes a system for providing high security for personal computers and work stations.

U.S. Pat. No. 5,577,209 depicts a multi-level security apparatus and method for a network employing a secure network interface unit (SNIU) coupled between each host or user computer unit and a network, and security management architecture, including a security manager coupled to the network, for controlling the operation and configuration of the SNIUs coupled to the network.

U.S. Pat. No. 5,623,601 discloses an apparatus and method for providing a secure firewall between a private network and a public network. The advantage is a transparent firewall with application level security and data screening capability.

U.S. Pat. No. 5,802,178 describes a multi-level security device for providing security between a user and at least one computer network, wherein the user is selected from the group consisting of a host computer and at least a second network.

WO04017210A1 describes a multimemory, physically isolated PC security device which adopts network isolation system to physically isolate the protected data from network and nullify possibility of illegal users attacking confidential data online. The protect card is used to minimize the possibility of decoding the confidential data when illegal user uses the PC or when the hard disk is lost preventing him from reading the files or logical structure in hard disk under protection. The system under protection could not log in LAN and when switching the system, the network isolation system would monitor all storage media and cut switch under abnormal condition.

### OBJECTS OF THE PRESENT INVENTION

The primary object of the present invention is to provide a system and a method to perform a secured data communication between an organizational network and other networks by physically isolating the organizational network from other networks.

An object of the present invention is to provide a system and a method to provide a higher-level security to an organizational network during data communication by physically isolating the organizational network from other networks by establishing phantom mode of connectivity.

Another object of the present invention is to provide a system and a method to permit secured data communication among the networks by phantom mode of connectivity using toggling means.

### SUMMARY OF THE PRESENT INVENTION

The present invention provides a system for providing a higher level security to data communication in computer networks, said system comprising; an organizational network, at least a third party network, at least a phantom server with an intermediate data storage, a toggling means disposed to isolate the organizational network from the third party network and said toggling means further disposed to permit secured data communication between the organizational network and the third party network through the phantom server. A method for providing a higher level security to data communication in computer networks by effecting the transmission of data between organizational network and the third party network by toggling means through phantom server.

### BRIEF DESCRIPTION OF THE DRAWINGS

FIG. 1 is an exemplary system architecture of the present invention depicting toggling means and the Phantom connectivity in a computer network.

FIGS. 2-6 depict exemplary system of the present invention depicting the functional flow of the data between the organizational network and the third party networks.

FIGS. 7-9 depict exemplary system of the present invention where the third party network is compromised by hacking.

FIG. 10 depicts the exemplary implementation of Intrusion Detection System (IDS)/Intrusion Prevention System (IPS) to protect phantom server configuration monitoring and guarding according to the present invention.

FIG. 11 shows the exemplary realization of a toggle switch using modem and telephone line through internal EPABX according to the present invention.

FIGS. 12-14 show an exemplary realization of the toggle switch using 4 Pole 2 Way Digital Switch Circuit (DSC) according to the present invention.

FIG. 15 shows an exemplary model of connectivity that enables organization network to communicate with any network keeping itself isolated from all the other networks according to the present invention.

FIG. 16-16A is a flowchart depicting the functional flow of the data communication between the organizational network and the third party network by using the method of the present invention.

### DETAILED DESCRIPTION OF THE INVENTION

Accordingly, the present invention provides a system and method for providing a higher level security to an organizational network by means of phantom connectivity.

The system of the present invention comprising an organizational network (25), at least a third party network (29), at least a phantom server (1) with an intermediate data storage, a toggling means (4) disposed to isolate the organizational network (25) from the third party network (29) and said toggling means (4) further disposed to permit secured data communication between the organizational network (25) and the third party network (29) through the phantom server (1). The third party network (29) comprises public domain networks or/and proprietary networks. The organizational network (25) comprises an organizational proxy server (3). The third party network (29) comprises a third party proxy server (2). The phantom server (1) is an independent entity not forming part of either the organizational or the third party network. The intermediate data storage of the phantom server further comprises an organizational network memory (5) and a third party network memory (6). In the present invention the toggling means (4) is a toggle switch, which is a digital toggle switch or a modem-based toggle switch or a mechanical toggle switch.

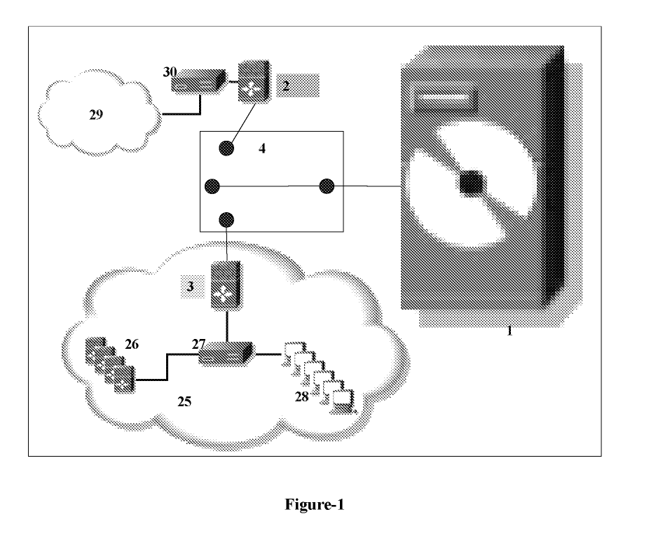

The system of the present invention is now described by referring to FIGS. 1-15. Initially referring to FIG. 1 of the accompanied diagrams the system of the present system is described. In the system of the present invention an organisational network (25) comprising a plurality of internal users (28) and local servers (26) connected to a switch (27), which is further connected to the organizational proxy server (3). The internal users (28) are generally workstations or desktops that are used to seek the resources of a network of an organization. The local servers (26) adopted in the system can be a web server, a file server or a print server or any other device that can act as a resource for the internal users (28) in a network. The switch (27) is a data-link layer device provided to connect the local servers (26), internal users (28) and the organizational proxy server (3). The organizational proxy server (3) is a server that carries out data communication with the organizational users on behalf of a third party network (29). The organizational proxy server (3) is also provided with temporary storage locations to enable storage of data. The expression data as used in the specification generally refers to harmless entity, which does not create any security threat. It also includes any instruction set generated by the organization to carry out a specific task.

The third party network (29) as expressed here includes public domain networks such as Internet and other proprietary networks, with which users of the organizational network (25) seek connectivity for data communication. The third party network is connected to the third party proxy server (2) through the switch (30). The third party proxy server (2) is disposed provide connectivity to the third party network (29) to communicate with the world on behalf of the organizational network (25). The third party proxy server (2) stores the data collected from the third party network (29) for the organization in its temporary locations.

A toggling means (4) is connected externally to the phantom Server PS (1) and electronically controlled by PS (1), thereby enabling PS (1) to either connect to organizational proxy server (3) or third party proxy server (2). The toggling means (4) is a toggle switch, that is either a modem-based (16) or a digital toggle switch (17) or a mechanical toggle switch controlled either by a digital or analogue circuit.

The phantom server (1) is a server class computer system; comprising one RS232 or RS 442 port or other similar interface means (19), toggling scripts and data communication scripts. Toggling scripts generate a command that is communicated to toggling means (4) through RS232 or RS442 port or other similar interface (19) to connect it either with third party proxy server (2) or organizational proxy server (3) as required. Data communication script is responsible to transfer the data to and from PS (1) intermediate data storage to and from third party proxy server (2) or organizational proxy server (3) when connected. Data communication script is also used for closing the sessions after the communication is over.

Some of the non-limiting toggling means that can be used in the system of the present invention are described below. Further, the system of the present invention can also be implemented by way of using other compatible toggling means.

A modem when used as a toggling means (4) is now described, by referring to FIG. 11. The toggling means (4) uses modems M1, M2, M3 and telephone line through internal EPABX (16). The modem connectivity configuration on the PS (1), organizational proxy server (3), third party proxy server (2) and EPABX (16) is made in such a fashion that only PS (1) can connect to organizational proxy server (3) or third party proxy server (2). The organizational proxy server (3) has one network card using which it is connected to the organizational network (25). Additionally, it has a dialup modem (M3) connected to a telephone exchange/EPABX (16). In the same way third party proxy server (2) is connected to third party network (29) through its LAN card. Additionally, it has a dialup modem (M2) connected to a telephone exchange/EPABX (16). The PS (1) of the present system can also be configured by way of incorporating a network card in case the PS (1) is to be secured by IDS/IPS (15) networks. PS (1) has one dialup modem (M1) configured in dial-out only mode so that it can dial either to organizational proxy server (3) or third party proxy server (2) to provide enhanced security. One modem can connect to any one modem at a time. However, the requirement of the number of modems as toggling means (4) depends on the type and the total number of networks, which are communicating with each other. For instance in case of N number of networks, N+1 modems are required, wherein the extra modem is used to connect the phantom server.

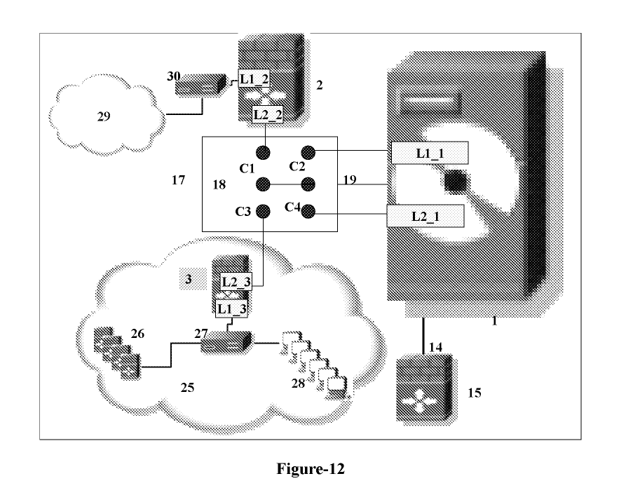

A digital toggle switch when used as toggling means is now described by referring to FIG. 12. The digital toggle switch (17) is a 4 Pole 2 Way toggle switch, which is otherwise referred to as Digital Switch Circuit (DSC). The digital toggle switch (17) comprises four network connectors (C1, C2, C3 & C4). The network connector is RJ45 type of connector or any other compatible connectors, which has poles for Tx+, Tx−, Rx+ and Rx−. The network connector can also be any other communication mechanism like, Universal serial bus (USB). A circuit connector (18) is disposed to provide a selective connectivity between the network connectors C1 & C2 or C3 & C4. The connectivity among the network connectors C1-C4 is now explained. The first connector (C1) is connected to the third party proxy server (2), second and third connectors (C2, C4) are connected to PS (1) and the fourth connector (C3) is connected to organizational proxy server (3).

The third party proxy server (2) comprises two LAN cards (L1_2 & L2_2). The LAN card (L1_2) is connected to the third party network (29) while LAN card (L2_2) is connected to DSC. The LAN card is a local area network card and any type of LAN card can be used for a computer system. It can also be designed using other communication mechanism like, USB based. The organizational proxy server (3) comprises two LAN cards (L1_3 & L2_3). The LAN card (L1_3) is connected to organizational network (25) while LAN card (L2_3) is connected to DSC. PS (1) comprises two LAN cards (L1_1 & L2_1) and both are connected to DSC. LAN card (L1_1) is configured for connection with third party network (29) while LAN card (L2_1) is configured for connection with the organizational network (25). DSC is connected to PS (1) through RS-232 or RS-442 or USB or any other similar interface (19) to receive control commands.

The above toggling means can also be implemented by using other toggle switches like electronic controlled mechanical relay switch (ECMRS). On receiving a command generated by a toggling script running on PS (1), over RS232 or RS442 or any other similar interface (19) port, ECMRS toggles its connection from one to another using mechanical relay switch.

In an embodiment of the present invention, a method for providing a higher level security to data communication in computer networks, said method comprising the steps of: transmitting data from an internal network of an organizational network (25) to an organizational proxy server (3) and storing it, establishing a connectivity between the organizational proxy server (3) and a phantom server (1) by toggling means (4) and transmitting the stored data from the organizational proxy server (3) to an organizational network memory (5) of an intermediate data storage of the phantom server (1), isolating the organizational proxy server (3) from the phantom server (1) by toggling means (4), establishing a connectivity between the phantom server (1) and a third party proxy server (2) of a third party network (29) by said toggling means (4), transmitting the data from the organizational network memory (5) of the intermediate data storage of the phantom server (1) to the third party proxy server (2), transmitting the desired data from the third party proxy server (2) and storing the same in a third party network memory (6) of the intermediate data storage of the phantom server (1), isolating the third party proxy server (2) from the phantom server (1) by toggling means (4), re-establishing the connection between the phantom server (1) and the organizational proxy server (3) by said toggling means (4), and transmitting the data from the third party network memory (6) of the intermediate data storage of the phantom server (1) to the internal network through the organizational proxy server (3). In this method, the toggling means (4) is disposed to provide a phantom connectivity between the phantom server (1) and the organizational network (25) or the third party network (29) to permit the data communication.

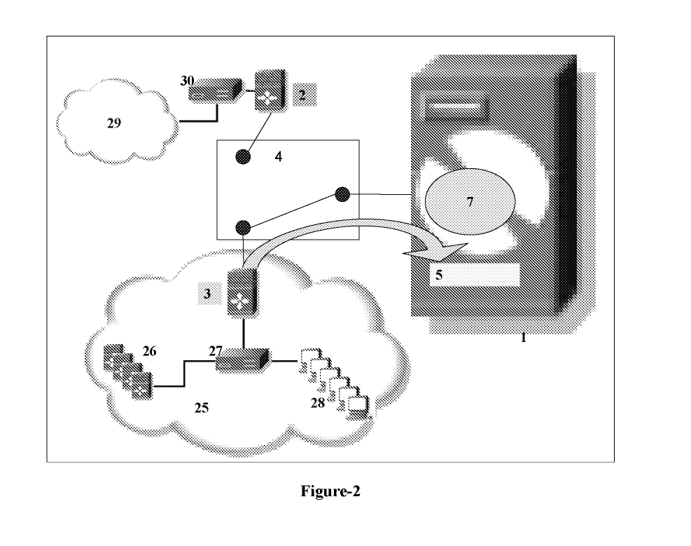

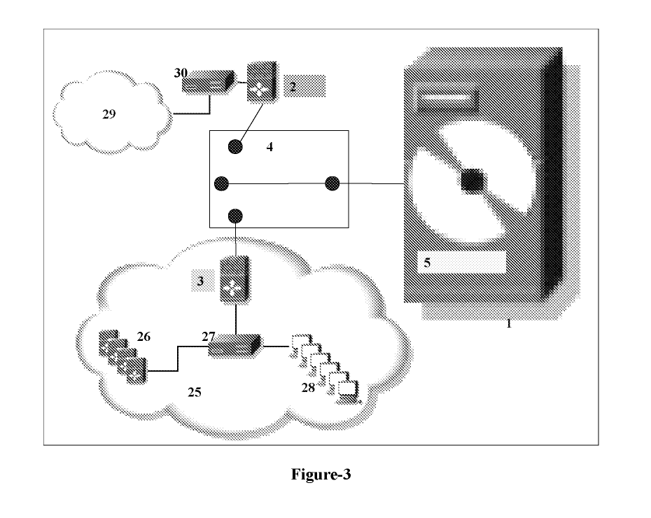

The method of the present invention is now further described by referring to FIG. 2-6.

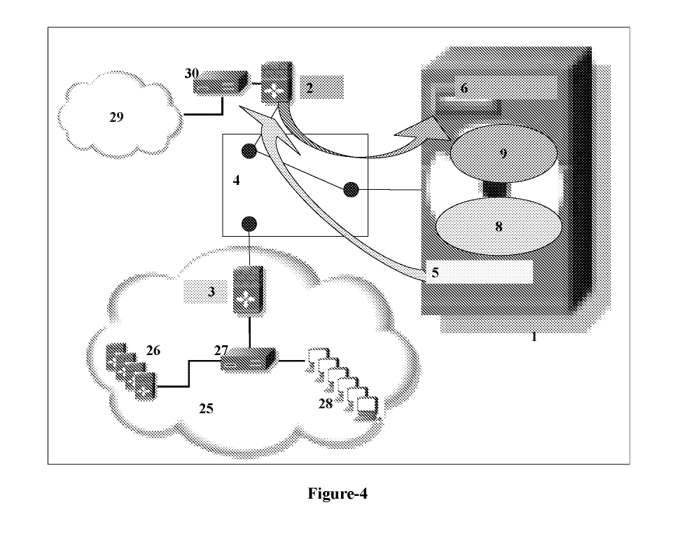

FIG. 2 shows that the PS (1) is connected to organizational proxy server (3) through toggling means (4). The organizational proxy server (3) having the data transmitted from the internal network of the organizational network (25) and stored in its temporary data storage. PS (1) launches a session on itself by facilitating by running a script for the data transfer (7) from organizational proxy server (3) to PS (1) that transmits all the data from organizational proxy server (3) to the organizational network memory (5) of the intermediate data storage of the PS (1). This script is developed using TCP/IP for email data and file transfer. However, other suitable scripts or programs can be developed in order to implement the system of the present invention on other network platforms, applications or other protocols. The data communication between PS (1) and organizational proxy server (3) can be performed through standard network protocols like SMTP or FTP etc., or proprietary network protocols. Once the data transfer from organizational proxy server (3) to PS (1) is completed, isolation or disconnection process of the organizational proxy server (3) from PS(1) is executed as shown in FIG. 3.

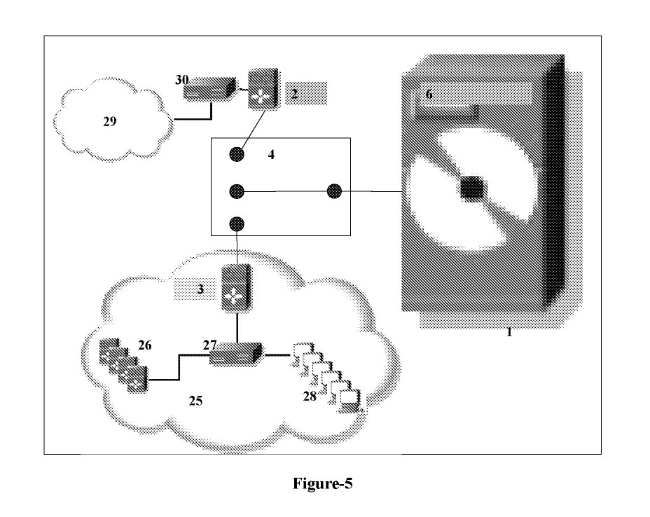

FIG. 3 shows that PS (1) is isolated or disconnected from organizational proxy server (3) and kills its data communication session. For isolating or disconnecting PS (1) from organizational proxy server (3), an additional time-out trigger is generated, if required, on which the connection is disconnected at proper data boundary/sync. The data boundary/sync point is the point at which the end of current data communication is reached. For example, when an email or a file is being transferred, it should not be interrupted in between for disconnection. It needs to wait till current file or email is completely transferred. It will not initiate the transfer of another email or file. It preserves the information about the remaining emails or files. This sync point information will be used to resume the transfer on reconnection. There are several tools like DAP, SmartFTP, GridFTP, etc which have implemented intelligent mechanism to maintain the sync points within current file which allows user to stop the data communication at time and resume the data transfer of current file from the sync point later on. One can implement such intelligence in data communication script or by means of an interface tool and interrupt the data transfer at any time for disconnection. The disconnection can also take place when all the data in organizational proxy server (3) temporary data storage is transmitted to organizational network memory (5) of the intermediate data storage of the PS (1) and organizational proxy server (3) temporary data storage becomes empty. Consequently, PS (1) which was connected to organizational proxy server (3) during the stage of data storage is now physically isolated from organizational proxy server (3). Once the isolation of the organizational proxy server (3) from the PS (1) is achieved, the connection between third party proxy server (2) and PS (1) is established as shown in FIG. 4.

FIG. 4 shows that now PS (1) is connected to third party proxy server (2) through toggling means (4). PS (1) launches two sessions, one for transmitting data from the organizational network memory (5) of the intermediate data storage of the PS (1) to third party proxy server (2) by running a script for data transfer (8) from PS (1) to third party proxy server (2) and another to transmit data from third party proxy server (2) to third party network memory (6) of the intermediate data storage of PS (1) by running a script for data transfer (9) from third party proxy server (2) to PS (1). The data communication between PS (1) and third party proxy server (2) can be performed through standard network protocols like SMTP, FTP etc., or proprietary network protocols. Once the act of transmission of data from third party proxy server (2) to PS (1) and from PS (1) to third party proxy server (2) is accomplished the isolation of PS (1) from third party proxy server (2) is performed as shown in FIG. 5.

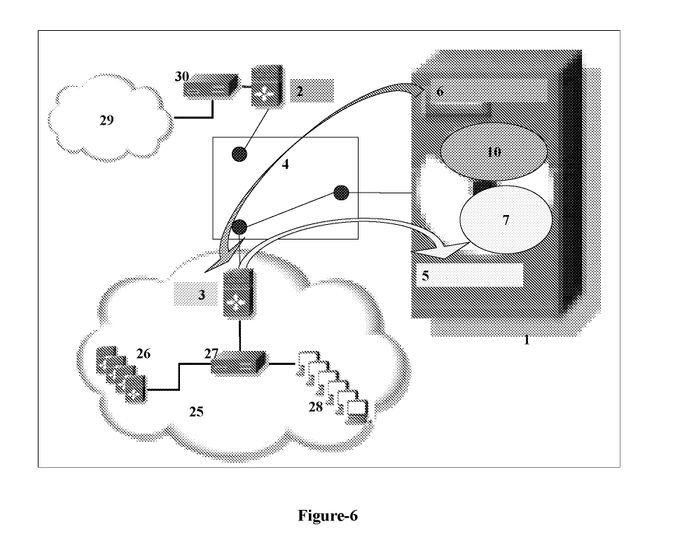

FIG. 5 shows that PS (1) is isolated or disconnected from third party proxy server (2) and kills all the live sessions. For isolating or disconnecting PS (1) from third party proxy server (2), an additional time-out trigger is generated if required, on which the connection is disconnected at proper data boundary/sync as described above or disconnection can also take place when all the data in third party proxy server (2) temporary data storage is transmitted to public network memory of the intermediate data storage (6) of PS (1) and third party proxy server (2) temporary data storage becomes empty as well as all the data from organizational network memory (5) of the intermediate data storage of the PS (1) is transmitted to third party proxy server (2). The organizational network memory (5) of the intermediate data storage of the PS (1) is empty while third party network memory (6) of the intermediate data storage of PS (1) contains recent data transmitted from third party proxy server (2). Once the isolation of PS (1) and third party proxy server (2) is achieved the connection between PS (1) and organizational proxy server (3) is accomplished as shown in FIG. 6.

FIG. 6 shows that PS (1) is again connected to organizational proxy server (3) through toggle switch (4). PS (1) launches two sessions, one for transmitting the data from third party network memory (6) of the intermediate data storage of PS (1) to organizational proxy server (3) by running a script for data transfer (10) from PS (1) to organizational proxy server (3) and another to transmit data from organizational proxy server (3) to organizational network memory (5) of the intermediate data storage of the PS (1) by running a script for data transfer (7) from organizational proxy server (3) to PS (1) and so data communication takes place transparently according to requirement.

By performing aforementioned steps, data communication is accomplished between a third party network (29) and organizational network (25) through phantom server PS (1) by toggling means (4), thereby achieving the selective connectivity and as well as maintaining isolation of the devices of the networks.

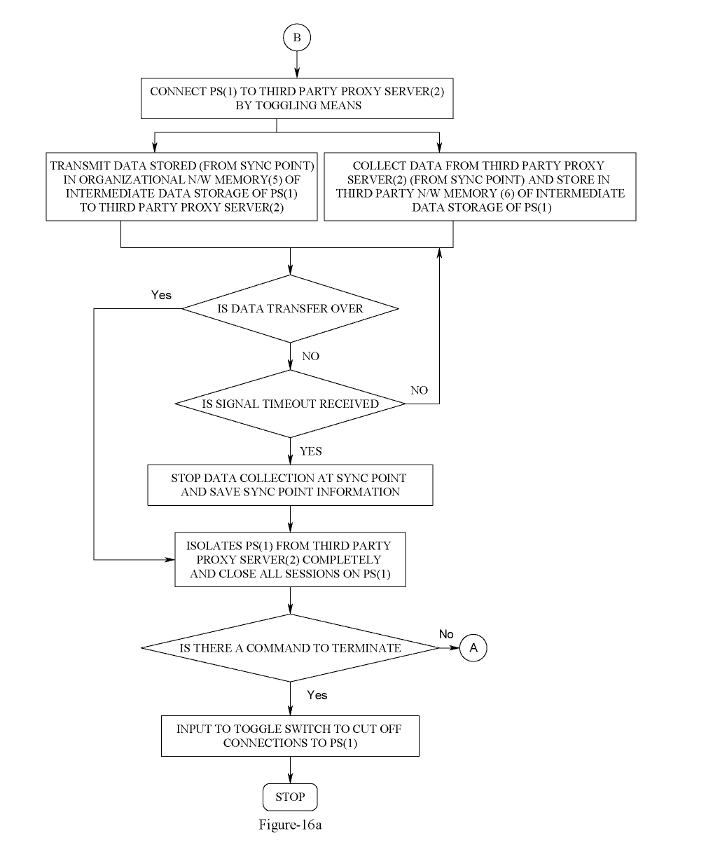

The above-mentioned implementation of the system and method of the present invention can be further explained with the help of flowchart as specified in FIG. 16. The system first checks of any previous connection between PS (1) and organizational proxy server (3) or between PS (1) and third party proxy server (2). If any connection is there, isolation or disconnection takes place by toggling means (4) between the PS (1) and organizational proxy server (3) or PS (1) and third party proxy server (2) and all the previous data from intermediate data storage of PS (1) get erased and sync points are initialized to set the transfer of new data to PS (1). If no connection is there, then because of some long time back connection the data that is present in intermediate data storage of PS (1) get erased and sync points are initialized to set the transfer of new data to PS (1). A connection is established between PS (1) and organizational proxy server (3) by toggling means for data communication. After the data has transferred from organizational proxy server (3) to PS (1) or from PS (1) to organizational proxy server (3), the isolation or disconnection of organizational proxy server (3) from PS (1) takes place. If data is not yet transferred completely then a signal timeout is checked. If signal timeout is not received, the data transfer continues. But if it is received, then data collection is stopped at sync point and sync point is saved and after that isolation or disconnection of organizational proxy server (3) from PS (1) takes place. Then a connection is established between PS (1) and third party proxy server (2) by toggling means (4) for data communication. The same procedure as described above is repeated for data transfer between PS (1) and third party proxy server (2). After the data communication between PS (1) and third party proxy server (2) is over, a command to terminate is checked. If received, no more connections take place and process stops but if not received then the whole procedure of data communication begins again and in this manner the process continues.

Furthermore, Intrusion Detection System (IDS)/Intrusion Prevention System (IPS) (15) through separate LAN (14) may be installed on PS (1), organizational proxy server (3) and third party proxy server (2), to provide an additional security.

The method of data communication between the third party network (29) and the organizational network (25) without physically connecting them is achieved by means of toggling, which is implemented by the following methods and are explained by referring to the FIGS. 11 to 15.

The system and method of present invention can use any kind of data communication mechanism using wired networks. Line of site oriented wireless technology, which provides physical isolation of two networks can also be used in place of wired network. The physical installation of PS (1), third party proxy server (2) and organizational proxy server (3) should be made in such a fashion that third party proxy server (2) and organizational proxy server (3) can never be in each other line of site and hence cannot communicate with each other. Only PS (1) is in line of site of third party proxy server (2) as well as organizational proxy server (3). PS (1) has only one wireless network device, which can either be connected to third party proxy server (2) or organizational proxy server (3) at a time.

The embodiments of the invention are now further described by means of the following further exemplary embodiments.

By referring to FIG. 11, a use of modem-based toggling switch to depict selective data communication is described. FIG. 11 shows the realization of the toggling means (4) using modems M1, M2, M3 and telephone line through internal EPABX (16). The modem connectivity configuration on the PS (1), organizational proxy server (3), third party proxy server (2) and EPABX (16) is made in such a fashion that only PS (1) can connect to organizational proxy server (3) or third party proxy server (2). The organizational proxy server (3) has one network card using which it is connected to the organizational network (25). Additionally, it has a dialup modem (M3) connected to a telephone exchange/EPABX (16). A Remote Access Server is configured in such a fashion that it accepts call only from a designated telephone number of PS (1). This is required as a security measure to ensure that no one else except PS (1) can connect to the organizational proxy server (3). In the same way third party proxy server (2) is connected to third party network (29) through its LAN card. Additionally, it has a dialup modem (M2) connected to a telephone line/EPABX (16). A Remote Access Server is configured in such a fashion that it accepts calls only from a designated telephone number of PS (1). This is required as a security measure to ensure that no one else except PS (1) can connect to third party proxy server (2). The PS (1) of the present system can also be configured by way of incorporating a network card in case the PS (1) is to be secured by IDS/IPS (15) networks. PS (1) has only one dialup modem (M1) configured in dial-out only mode so that it can dial either to organizational proxy server (3) or third party proxy server (2) to provide enhanced security. The dial-in mode is disabled on PS (1) so as to provide higher degree of isolation and security. In order to communicate using this technique PS (1) runs a script that can periodically connect to organizational proxy server (3) and third party proxy server (2) in cyclic fashion as described above. This script is developed using TCP/IP for email data as well as file transfer. Furthermore, EPABX (16) is configured in such a way that it allows only PS (1) telephone line to be connected to organizational proxy server (3) and third party proxy server (2) telephone lines. The organizational proxy server (3) and third party proxy server (2) telephone lines do not accept call from any other number. This provides higher degree of physical isolation and security. Furthermore, IDS/IPS (15) through separate LAN (14) may be installed on PS (1) organizational proxy server (3) and third party proxy server (2), which prevents alteration in the modem configuration and blocks the traffic if required and provides additional security.

In another exemplary embodiment, a digital toggling switch is used to show selective data communication by referring to FIG. 12. FIG. 12 shows the realization of toggle switch using 4 Pole 2 Way toggle switch (17) also called as Digital Switch Circuit (DSC). It comprises four network connectors (C1, C2, C3, & C4). A circuit connector (18) is disposed to provide a selective connectivity between the network connectors C1 & C2 or C3 & C4. The first connector (C1) is connected to third party proxy server (2), second and third connectors (C2, C4) are connected to PS (1) and fourth connector (C3) is connected to the organizational proxy server (3). The third party proxy server (2) comprises two LAN cards (L1_2 & L2_2); LAN card (L1_2) is connected to third party network (29) while LAN card (L2_2) is connected to DSC. The organizational proxy server (3) comprises two LAN cards (L1_3, L2_3); LAN card 1 (L1_3) is connected to organizational network (25) while LAN card 2 (L2_3) is connected to DSC. PS (1) comprises two LAN cards (L1_1, L2_1) and both are connected to DSC. LAN card (L1_1) is configured for connection with third party network (29) while LAN card (L2_1) is configured for connection with organizational network (25). DSC is connected to PS (1) through RS-232 or RS-442 or any other similar interface (19) to receive control commands.

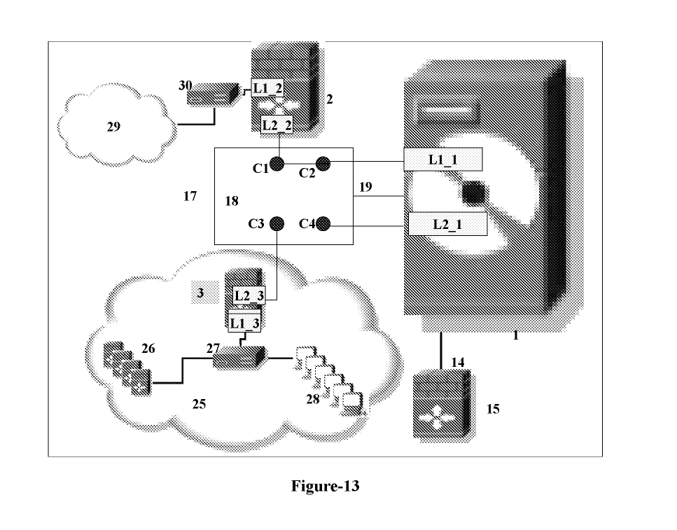

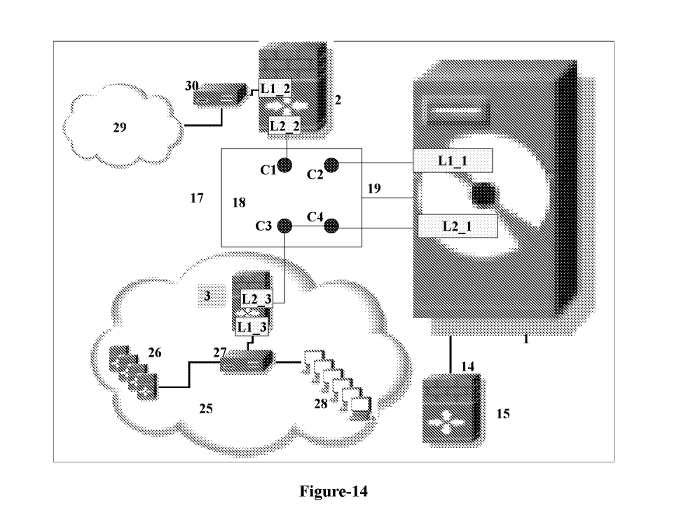

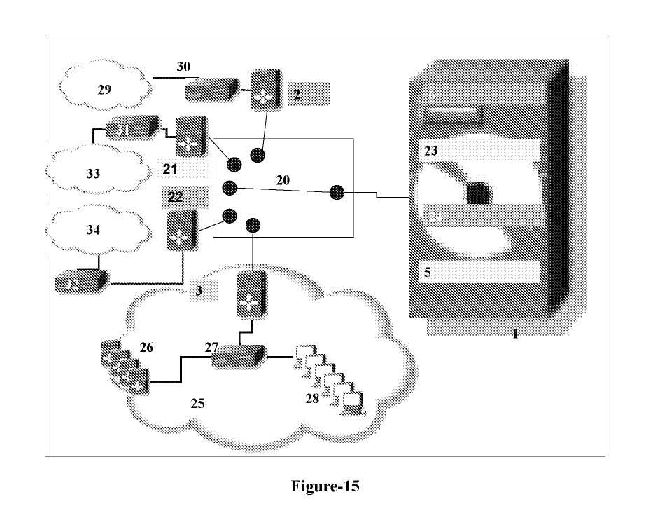

To perform these connections, PS (1) runs a script that sends command to digital circuit over RS-232 or RS-442 or any other similar interface (19). This script is developed using TCP/IP for email data and file transfer. However, other suitable scripts or programs can be developed in order to implement the system of the present invention on other network platforms, applications or other protocols. There are two types of command for this purpose. (1) Connect to third party proxy server (2) and (2) Connect to organizational proxy server (3). On receiving first command, the digital circuit first checks its state. If connectors C3 and C4 are found connected, it disconnects them and makes them open. Then it establishes connection between connectors C1 and C2. Similarly, on receiving second command, the digital circuit first checks its state. If connectors C1 and C2 are found connected, it disconnects them and makes them open. Then it establishes connection between C3 and C4. Thus, PS (1) connects to either of the two networks, does its predefined work and disappears just like a Phantom. The stated connection of third party proxy server (2) with PS (1) on receiving the Connect to third party proxy server (2) instruction is shown in FIG. 13 by connecting C1 and C2 of DSC to PS (1). Similarly, the stated connection of organizational proxy server (3) with PS (1) on receiving the Connect to organizational proxy server (3) instruction is shown in FIG. 14 by connecting C3 and C4 of DSC.

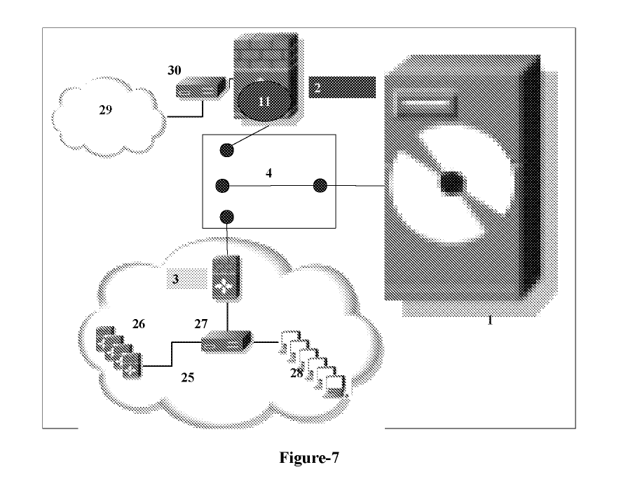

In yet another exemplary embodiment, wherein the reaction of system of the present invention in the event of an outside attack by referring to FIGS. 7-9 is described.

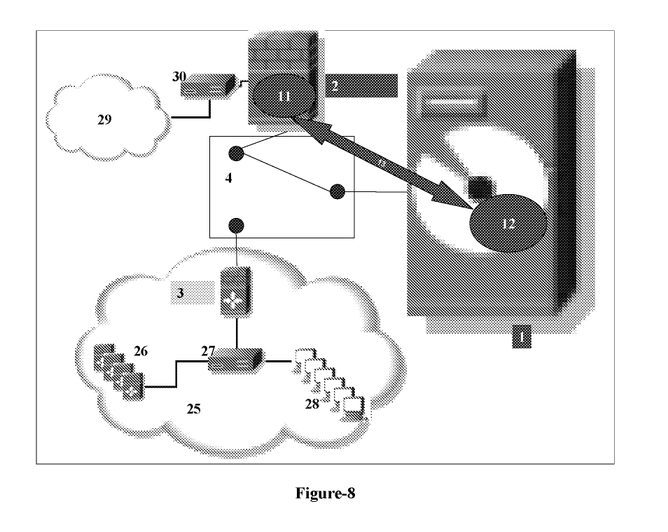

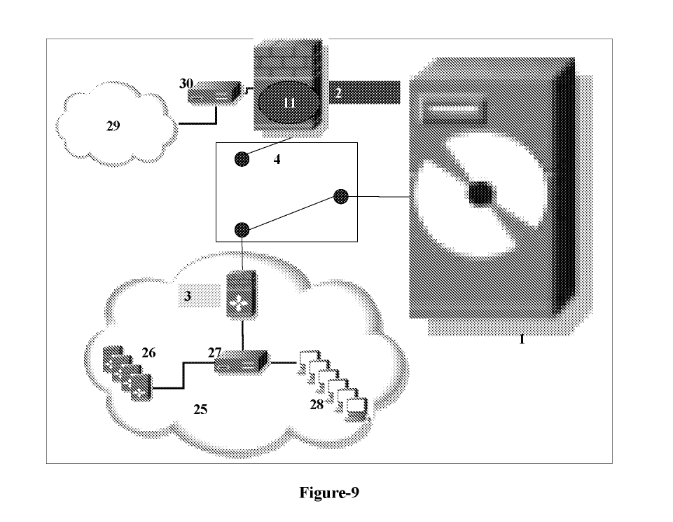

FIG. 7 shows that even if an attacker's session (11) on third party proxy server (2) is launched by the hacker, and third party proxy server (2) is hacked, its attack and penetration tools could not find any other network connected to third party proxy server (2) as PS (1) is connected to third party proxy server (2) for a small time duration only. Once the third party proxy server (2) is hacked, and connection is established between PS (1) and third party proxy server (2), the resulting situation is explained in FIG. 8.

FIG. 8 shows that when PS (1) is connected to hacked third party proxy server (2) through toggle switch (4), and a persistent hacker is able to launch an attacker's session (12) on PS (1) and get hold of it in a small time duration, then also, its attack and penetration tools could not find any other network connected to PS (1) as PS (1) is disconnected from third party proxy server (2) during the period before connecting to organizational proxy server (3). Once the data communication between PS (1) and third party proxy server (2) has taken place, isolation of third party proxy server (2) from PS (1) takes place and consequently hacking has no effect on organizational proxy server (3) which is shown in FIG. 9.

FIG. 9 shows that PS (1) will automatically get disconnected from hacked third party proxy server (2) before connecting to organizational proxy server (3). It also kills all sessions running on it. Thus, the attacker loses its communication link as well session (12) on the PS (1). His session (11) on third party proxy server will be alive but unable to launch any attack on the organizational network (25).

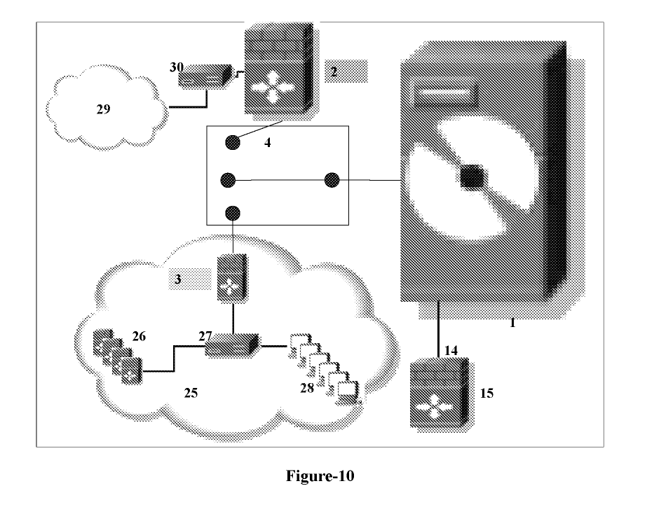

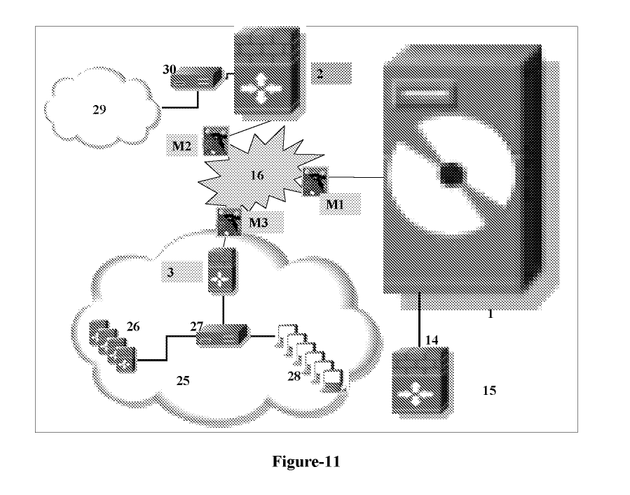

FIG. 10 shows the implementation of Intrusion Detection System (IDS)/Intrusion Prevention System (IPS) (15) through separate LAN (14) to protect PS (1) configuration monitoring and guarding in case a hacker attacks PS (1) through hacked third party proxy server (2). This also provides additional security.

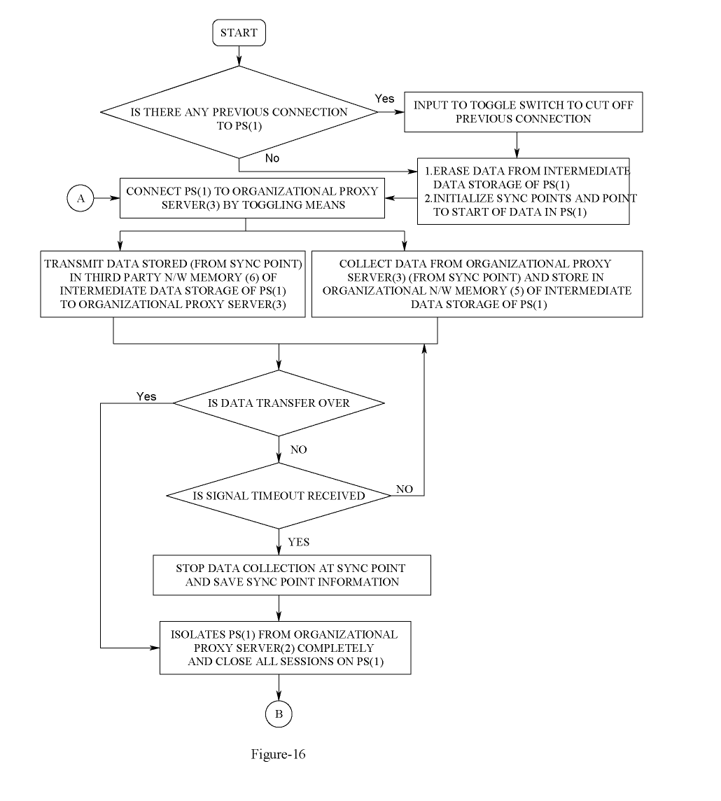

In further exemplary embodiment of the present invention, an application of a multi-port toggling switch to communicate with multiple networks is shown by referring to FIG. 15. The multi-port toggling switch (20) is modem-based (16) or a digital toggle switch (17) or a mechanical relay switch or an analogue toggle switch controlled either by a digital or analogue circuit. In case of modem based multi-port toggling switch, to enable the communication of PS (1) with any one network of N networks N+1 modems are required. In case of digital multi-port toggle switch, 4 pole N way switch is required which connects PS (1) to organizational proxy server (3) or third party proxy server (2) or any of the Network Proxies, NP-2 (21), NP-3 (22) of multiple networks at a time. FIG. 15 shows one-to-many, but one at a time, model of connectivity that enables organizational network (25) to communicate with any network keeping itself isolated from all the other networks. The network-2(33) is connected with a network proxy NP-2 (21) through a switch (31) and network-3 (34) is connected with network proxy NP-3 (22) through a switch (32). PS (1) connects to organizational proxy server (3), third party proxy server (2), NP-2 (21) and NP-3 (22) in predefined sequence and exchange the data between organizational proxy server (3) and respective proxy i.e. NP-2 (21) and NP-3 (22) through multi port toggle switch (20). This predefined sequence can be round robin, random etc. Similarly, on the PS (1), intermediate data space for NP-2 (23) and intermediate data space for NP-3 (24) is disposed as in case for organizational proxy server (3) and third party proxy server (2). This mechanism is extended for data communication among the multiple networks by modifying the data communication script.

In addition, the system of the present can be adapted to use a variety of additional security mechanisms in terms of firewall, IDS, IPS, filters, encryption etc. at its Internet gateway and organizational gateway or any other place for additional security.

Advantages:
1. The system and method of present invention is useful for any type of data communication with any network keeping its own network isolated.
2. The system and method of present invention is useful for any type of standard and proprietary proxies.
3. The system and method of present invention can be used with additional security implementation measures like Firewall, IDS, VPN, etc. over organization network including public network.
4. The system and method of present invention uses IDS/IPS as additional security measure over PS.
5. The system and method of present invention can be extended to multiple networks for data communication.

Many different embodiments of the present invention may be constructed without departing from the spirit and scope of the invention. It should be understood that the present invention is not limited to the specific embodiments as described in the specification. The present invention is intended to cover various modifications and equivalent arrangements included within the scope and spirit of the claims.

We claim:

1. A system for providing a higher level security to data communication in computer networks, said system comprising; an organizational network, at least a third party network, at least a phantom server with an intermediate data storage, a toggling means disposed to isolate the organizational network from the third party network and said toggling means further disposed to permit secured data communication between the organizational network and the third party network through the phantom server.

2. The system according to claim 1, wherein the third party network further comprises public domain networks and proprietary networks.

3. The system according to claim 1, wherein the organizational network further comprising an organizational proxy server.

4. The system according to claim 1, wherein the third party network further comprising a third party proxy server.

5. The system according to claim 1, wherein the phantom server is an independent entity not forming part of either the organizational or the third party network.

6. The system according to claim 1, wherein the intermediate data storage of the phantom server further comprises an organizational network memory and a third party network memory.

7. The system according to claim 1, wherein the toggling means is a toggle switch.

8. The system according to claim 7, wherein the toggle switch is a digital toggle switch or a modem-based toggle switch or a mechanical toggle switch.

9. A method for providing a higher level security to data communication in computer networks, said method comprising the steps of: transmitting data from an internal network of an organizational network to an organizational proxy server and storing it, establishing a connectivity between the organizational proxy server and a phantom server by toggling means and transmitting the stored data from the organizational proxy server to an organizational network memory of an intermediate data storage of the phantom server, isolating the organizational proxy server from the phantom server by toggling means, establishing a connectivity between the phantom server and a third party proxy server of a third party network by said toggling means, transmitting the data from the organizational network memory of the intermediate data storage of the phantom server to the third party proxy server, transmitting the desired data from the third party proxy server and storing the same in a third party network memory of the intermediate data storage of the phantom server, isolating the third party proxy server from the phantom server by toggling means, re-establishing the connection between the phantom server and the organizational proxy server by said toggling means, and transmitting the data from the third party network memory of the intermediate data storage of the phantom server to the internal network through the organizational proxy server.

10. The method according to claim 9, wherein the third party network further comprises public domain networks and proprietary networks.

11. The method according to claim 9, wherein the organizational network further comprises an organizational proxy server.

12. The method according to claim 9, wherein the third party network further comprises a third party proxy server.

13. The method according to claim 9, wherein the phantom server is an independent entity not forming part of either the organizational or the third party network.

14. The method according to claim 9, wherein the intermediate data storage of the phantom server further comprises an organizational network memory and a third party network memory.

15. The method according to claim 9, wherein the toggling means is a toggle switch.

16. The method according to claim 15, wherein the toggle switch is a digital toggle switch or a modem-based toggle switch or a mechanical toggle switch.

17. The method according to claim 9, wherein the toggling means disposed to provide a phantom connectivity among the phantom server, the organizational network and the third party network to permit the data communication.
